(19) United States
(12) Patent Application Publication
(10) Pub. No.: US 2016/0085924 A1
(43) Pub. Date: Mar. 24, 2016

(54) MEDICAL RESOURCE INTRODUCTION DEVICE, SYSTEM, RECORDING MEDIUM, AND METHOD FOR OPERATING MEDICAL RESOURCE INTRODUCTION DEVICE

(71) Applicant: FUJIFILM Corporation, TOKYO (JP)

(72) Inventors: HIRONORI MATSUMASA, TOKYO (JP); SATOSHI UEDA, TOKYO (JP); YUYA KUDO, TOKYO (JP); YASUNORI OHTA, TOKYO (JP); RYOSUKE USAMI, TOKYO (JP); TAKAMASA YAGUCHI, TOKYO (JP)

(73) Assignee: FUJIFILM Corporation, TOKYO (JP)

(21) Appl. No.: 14/835,613

(22) Filed: Aug. 25, 2015

(30) Foreign Application Priority Data
Sep. 19, 2014 (JP) 2014-191737

(51) Int. Cl. G06F 19/00

(52) U.S. Cl. CPC G06F 19/327

(57) ABSTRACT

A medical resource introduction device includes: a database access unit that accesses a medical resource database storing medical resource combination information and operation status information; an inoperable medical resource detection unit that detects an inoperable medical resource, based on the operation status information; a surplus resource determination unit that, in a case where the inoperable medical resource detection unit detects the inoperable medical resource, investigates whether there is a medical resource of which status is changed to a standby state due to an occurrence of the inoperable medical resource, based on the medical resource combination information, and determines that the medical resource is a surplus resource in a case where there is the medical resource of which status is changed to the standby state; and an introduction unit that introduces the surplus resource to any of the plurality of medical facilities.

### CROSS-REFERENCE TO RELATED APPLICATIONS

The present application claims priority under 35 U.S.C. §119 to Japanese Patent Application No. 2014-191737, filed on Sep. 19, 2014. Each of the above application(s) is hereby expressly incorporated by reference, in its entirety, into the present application.

### BACKGROUND OF THE INVENTION

1. Field of the Invention

The claimed invention relates to a medical resource introduction device, a system, a recording medium, and a method for operating a medical resource introduction device which introduce medical resources including medical devices and medical staffs to a plurality of medical facilities.

2. Description of the Related Art

In a medical field, various medical computer systems have been proposed. As one of the medical computer systems, JP2008-509500A discloses a doctor introduction system which introduces doctors who have been registered in advance to medical facilities.

The doctor introduction system disclosed in JP2008-509500A includes a doctor introduction database in which information about the doctors who can be dispatched is registered, searches for a doctor who meets conditions from the doctor introduction database on the basis of an introduction request from the medical facility as a dispatch destination that wants the doctors and introduces the doctor from the search results. The requirements of the doctor who is a supply-side user and supplies labor are registered in the doctor introduction database. The doctor introduction system starts to provide an introduction service in response to an introduction request from a medical facility which is a demand-side user and wants the doctors.

The doctor introduction system disclosed in JP2008-509500A has the general structure of an introduction system which starts the introduction service on the basis of the demand of the user who is a supplier or a consumer. According to the doctor introduction system, it is possible to supplement the shortage of doctors in the medical facility and the doctor can find a desired job.

### SUMMARY OF THE INVENTION

As described as a precondition in the doctor introduction system disclosed in JP2008-509500A, there is a medical facility that is short of doctors and there is a doctor who finds the desired medical facility that the doctor will work for. In society as a whole, actually, there is an imbalance between the demand and supply of doctors. This situation is applied to all medical staffs including nurses and radiology technologists, in addition to the doctors. In addition, this situation is not limited to the medical staffs and is also applied to all medical resources including medical devices. For example, it is considered that a given medical facility has surplus medical devices and another medical facility is short of the same type of medical device as the surplus medical device.

The doctor introduction system disclosed in JP2008-509500A is one measure to correct the imbalance between the demand and supply of the medical resources. However, for example, the introduction system according to the related art, such as the doctor introduction system disclosed in JP2008-509500A, has the problem that it is less likely to operate effectively when a large-scale disaster that has a wide effect on the entire area occurs.

That is, a damaged area requires support, such as the supply of medical resources from areas other than the damaged area. In the damaged area, the medical resources can be circulated between a plurality of medical facilities in the damaged area since a damage situation varies depending on the medical facility.

For example, the following case is considered: a case in which, in a given medical facility, medical staffs are injured and unavailable and medical devices which can be used by the medical staffs are operable, that is, surplus medical devices (for example, X-ray equipment) are generated since the medical staffs (for example, radiology technologists) are inoperable. In addition, conversely, there is a case in which, since medical devices are inoperable, surplus medical staffs are generated in another medical facility. As such, when there is a combination of operable medical resources, that is, the medical staff and the medical device, and one of the medical resources is inoperable, the other medical resource is in a standby state and becomes a surplus resource.

Usually, the following action is considered: the medical facility which has surplus medical resources or is short of medical resources transmits a request including requirements to the doctor introduction system disclosed in JP2008-509500A and waits for introduction. However, in many cases, in the damaged area, the damaged medical facility is not operated, while holding the surplus resources. In this case, a request related to the supply or demand of the medical resources is not transmitted from the medical facility to the doctor introduction system. As a result, latent surplus resources which are not actualized by a request are generated and are not used.

In the damaged area, when the medical resources are circulated between a plurality of medical facilities having the latent surplus resources, it is possible to effectively use the surplus resources and to accelerate the recovery of medical activity in the damaged area.

However, as described above, the doctor introduction system disclosed in JP2008-509500A is an introduction system having a general structure according to the related art which starts services on the basis of the request from the supply-side or demand-side user. Therefore, the doctor introduction system has the problem that it does not effectively operate in a situation in which one of the supply-side user and the demand-side user does not transmit a request or is less likely to transmit a request as in the damaged area and does not effectively use the latent surplus resources.

The claimed invention has been made to provide a medical resource introduction device, a system, a recording medium, and a method that can operate effectively even in a situation in which there is no request from a user who is a medical resource supplier or consumer and can use medical resources which are latent surplus resources.

A medical resource introduction device according to an aspect the claimed invention that introduces medical resources including at least one of medical devices and medical staffs held by a plurality of medical facilities to the plurality of medical facilities in order to circulate the medical resources between the plurality of medical facilities, includes: a database access unit that accesses a medical resource database storing medical resource combination information and operation status information, the medical resource combination information registering at least one combination of the medical resources that are operated in cooperation with each other in each medical facility, the operation status information indicating whether each of the medical resources held by each medical facility is operable or inoperable; an inoperable medical resource detection unit that detects an inoperable medical resource among the medical resources included in the combination, based on the operation status information; a surplus resource determination unit that, in a case where the inoperable medical resource detection unit detects the inoperable medical resource, investigates whether there is a medical resource of which status is changed to a standby state in which the medical resource stands by to be operated due to an occurrence of the inoperable medical resource, based on the medical resource combination information, and determines that the medical resource is a surplus resource in a case where there is the medical resource of which status is changed to the standby state; and an introduction unit that introduces the surplus resource to any of the plurality of medical facilities.

The medical resource combination information may include a first combination, which is a pair of the medical resources, and in a case where one of the medical resources consisting the first combination is detected as the inoperable medical resource, the surplus resource determination unit may determine the other medical resource of the first combination, which makes the pair with the inoperable medical resource, as the surplus resource.

The medical resource combination information may include a second combination of at least one first medical resource and a plurality of second medical resources which are operated in cooperation with the first medical resource among the medical resources, and in a case where the second medical resources are detected as the inoperable medical resource and there is no second medical resource that is operable in the second combination, the surplus resource determination unit may determine the first medical resource as the surplus resource.

The combinations of the medical resource may include a combination in which one of the medical resources is the medical staff and the other which constitutes the combination with the medical staff is the medical device.

In a case where there is the surplus resource in one medical facility, the introduction unit may search for a medical facility having a medical resource that is capable of being operated in cooperation with the surplus resource from the medical resource database and may introduce the surplus resource to the searched medical facility.

The medical resource introduction device according to the above-mentioned aspect may further include an approval unit that, before the introduction unit introduces the surplus resource, inquires of the medical facility, which is an introduction source having the surplus resource, about the introduction of the surplus resource and obtains the approval of the introduction from the medical facility, which is the introduction source.

The medical resource introduction device according to the above-mentioned aspect may further include an operation status information update unit that updates the operation status information on the basis of information which is periodically transmitted from the medical resource.

Further, a medical resource introduction system according to another aspect of the claimed invention that introduces medical resources including at least one of medical devices and medical staffs held by a plurality of medical facilities to the plurality of medical facilities in order to circulate the medical resources between the plurality of medical facilities, includes: client terminals that are installed in each of the plurality of medical facilities; and a medical resource introduction device that introduces the medical resources to the client terminals, in which the medical resource introduction device includes: a database access unit that accesses a medical resource database storing medical resource combination information and operation status information, the medical resource information registering at least one combination of the medical resources that are operated in cooperation with each other, the operation status information indicating whether each of the medical resources is operable or inoperable in such a manner that the medical facilities holding each medical resource can be identified; an inoperable medical resource detection unit that detects an inoperable medical resource among the medical resources included in the combination, based on the operation status information; a surplus resource determination unit that, in a case where the inoperable medical resource detection unit detects the inoperable medical resource, investigates whether there is a medical resource of which status is changed to a standby state in which the medical resource stands by to be operated due to an occurrence of the inoperable medical resource, based on the medical resource combination information, and determines that the medical resource is a surplus resource in a case where there is the medical resource of which status is changed to the standby state; and an introduction unit that introduces the surplus resource to any of the plurality of medical facilities.

Further, a non-transitory computer-readable recording medium storing a medical resource introduction program according to still another aspect of the claimed invention that causes a computer to function as a medical resource introduction device which introduces medical resources including at least one of medical devices and medical staffs held by a plurality of medical facilities to the plurality of medical facilities in order to circulate the medical resources between the plurality of medical facilities and causes the computer to perform: a database access step of accessing a medical resource database storing medical resource combination information and operation status information, the medical resource combination information registering at least one combination of the medical resources that are operated in cooperation with each other, the operation status information indicating whether each of the medical resources is operable or inoperable such that the medical facilities holding each medical resource can be identified; an inoperable medical resource detection step of detecting an inoperable medical resource among the medical resources included in the combination, based on the operation status information; a surplus resource determination step of, in a case where the inoperable medical resource is detected in the inoperable medical resource detection step, investigating whether there is a medical resource of which status is changed to a standby state in which the medical resource stands by to be operated due to the occurrence of the inoperable medical resource, based on the medical resource combination information, and determining that the medical resource is a surplus resource in a case where there is the medical resource of which status is changed to the standby state; and an introduction step of introducing the surplus resource to any of the plurality of medical facilities.

Further, a method for operating a medical resource introduction device according to still another aspect of the claimed invention that introduces medical resources including at least one of medical devices and medical staffs held by a plurality of medical facilities to the plurality of medical facilities in order to circulate the medical resources between the plurality of medical facilities, the method including: a database access step of accessing a medical resource database storing medical resource combination information and operation status information, the medical resource combination information registering one combination of the medical resources that are operated in cooperation with each other, the operation status information indicating whether each of the medical resources is operable or inoperable in such a manner that the medical facilities holding each medical resource can be identified; an inoperable medical resource detection step of detecting an inoperable medical resource among the medical resources included in the combination, based on the operation status information; a surplus resource determination step of, in a case where the inoperable medical resource is detected in the inoperable medical resource detection step, investigating whether there is a medical resource of which status is changed to a standby state in which the medical resource stands by to be operated due to the occurrence of the inoperable medical resource, based on the medical resource combination information, and determining that the medical resource is a surplus resource in a case where there is the medical resource of which status is changed to the standby state; and an introduction step of introducing the surplus resource to any of the plurality of medical facilities.

According to the claimed invention, when a medical resource is inoperable, the medical resource introduction device investigates whether the medical resource of the other party which is operated in cooperation with the medical resource is changed to a standby state in which the medical resource waits for an operation. When the medical resource is changed to the standby state, the medical resource of the other party is determined to be a surplus resource and is introduced. Therefore, the medical resource introduction device can operate effectively even in a situation in which there is no request from the user who is a medical resource supplier or consumer and can use the medical resources which are latent surplus resources.

### BRIEF DESCRIPTION OF THE DRAWINGS

FIG. 1 is a diagram illustrating the structure of a medical resource introduction system.

FIG. 2 is a diagram illustrating an example of medical resource combination information.

FIG. 3 is a diagram illustrating an example of operation status information.

FIG. 4 is a block diagram illustrating the electrical structure of a computer which is used in, for example, a medical resource introduction server.

FIG. 5 is a diagram illustrating the outline of the functions of the medical resource introduction server.

FIG. 6 is a diagram illustrating an example of an input screen for inputting the medical resource combination information.

FIG. 7 is a diagram illustrating an example of an input screen for inputting the operation status information.

FIG. 8 is a flowchart illustrating a surplus resource determination process.

FIG. 9 is a diagram illustrating an example of an introduction screen for introducing surplus resources.

FIG. 10 is a diagram illustrating an example of medical resource combination information.

FIG. 11 is a flowchart illustrating a surplus resource determination process.

FIG. 12 is a diagram illustrating an example of the medical resource combination information.

FIG. 13 is a diagram illustrating the outline of the functions of a medical resource introduction server.

FIG. 14 is a diagram illustrating the outline of the functions of a medical resource introduction server.

FIG. 15 is a diagram illustrating an example of a structure for automatically updating the operation status information.

### DESCRIPTION OF THE PREFERRED EMBODIMENTS

### First Embodiment

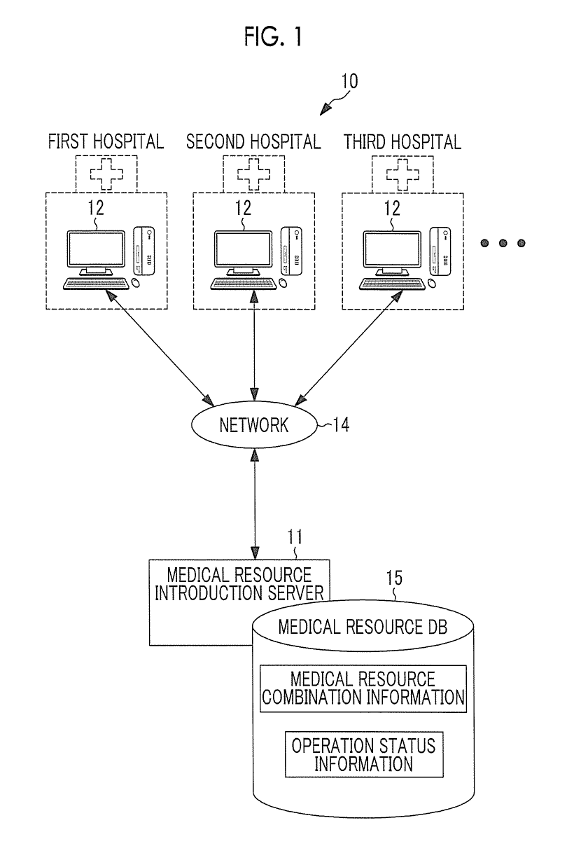

A medical resource introduction system 10 illustrated in FIG. 1 is a computer system that is used to circulate medical resources including medical devices and medical staffs between a plurality of medical facilities. The medical resource introduction system 10 includes a medical resource introduction server 11, a plurality of client terminals 12, and a network 14 that connects these components such that they can communicate with each other. The network 14 is, for example, the Internet.

The client terminal 12 is installed in each medical facility (a first hospital, a second hospital, and a third hospital in the example illustrated in FIG. 1) and is operated by, for example, an administrator who manages the medical resources of each medical facility. The client terminal 12 has a function which accesses the medical resource introduction server 11 and transmits various requests, a function which receives various kinds of information, such as a medical resource introduction notice transmitted from the medical resource introduction server 11, and a function which displays, for example, an operation screen used to transmit the received introduction notice or request.

The medical resource introduction server 11 includes a medical resource database (hereinafter, referred to as a medical resource DB) 15 that stores medical resource combination information and operation status information. The medical resource introduction server 11 is a medical resource introduction device according to the claimed invention which determines the surplus medical resources (surplus resources) of each medical facility on the basis of the medical resource combination information and the operation status information stored in the medical resource DB 15 and introduces the determined surplus resources to other medical facilities.

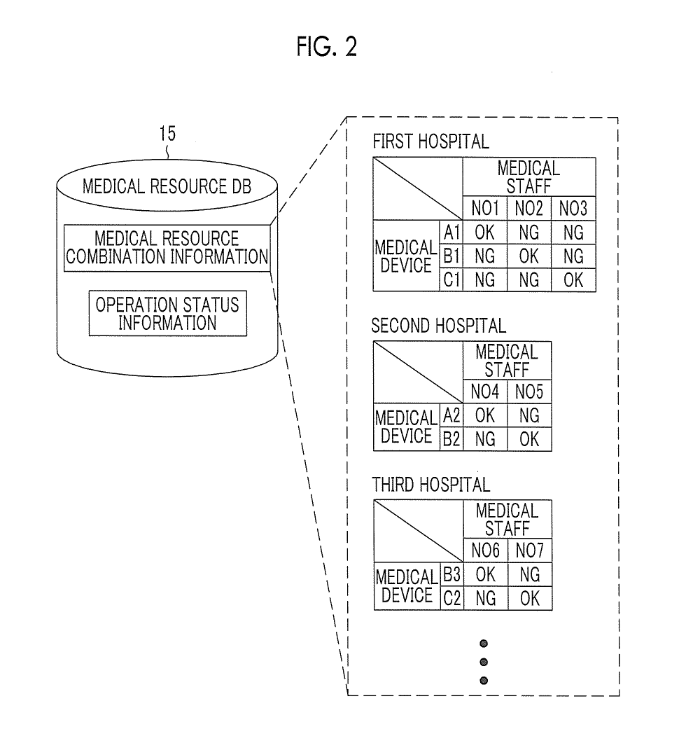

As illustrated in FIG. 2, the medical resource combination information is data indicating a combination (correspondence relationship) of the medical resources which operate in cooperation with each other. In the example illustrated in FIG. 2, the combinations of the medical resources which operate in cooperation with each other are registered so as to be distinguished from each other for each medical facility. Therefore, the medical resources of each medical facility can be identified. FIG. 2 illustrates an example in which combinations of the medical devices and the medical staffs who can use each medical device or actually use each medical device are registered as the medical resource combination information. In addition, FIG. 2 illustrates an example in which a first combination (a combination of two medical resources) in which one medical staff is associated with one medical device is registered as the medical resource combination information.

In FIG. 2, an index “OK” which is written at the intersection between each medical device (vertical axis) and each medical staff (horizontal axis) indicates that the medical staff can use the medical device or that the medical staff actually uses the medical device and an index “NG” indicates that the medical staff is not capable of using the medical device.

Specifically, the first hospital has three medical devices A1, B1, and C1. The medical device A1 is used by a medical staff NO1, the medical device B1 is used by a medical staff NO2, and the medical device C1 is used by a medical staff NO3. The second hospital has two medical devices A2 and B2. The medical device A2 is used by a medical staff NO4 and the medical device B2 is used by a medical staff NO5. The third hospital has two medical devices B3 and C2. The medical device B3 is used by a medical staff NO6 and the medical device C2 is used by a medical staff NO7.

The medical devices A1 and A2 are medical devices A of the same type, but are denoted by different reference numerals in order to identify, for example, the medical facilities having the medical devices. Similarly, the medical devices B1 to B3 are medical devices B of the same type and the medical devices C1 and C2 are medical devices C of the same type.

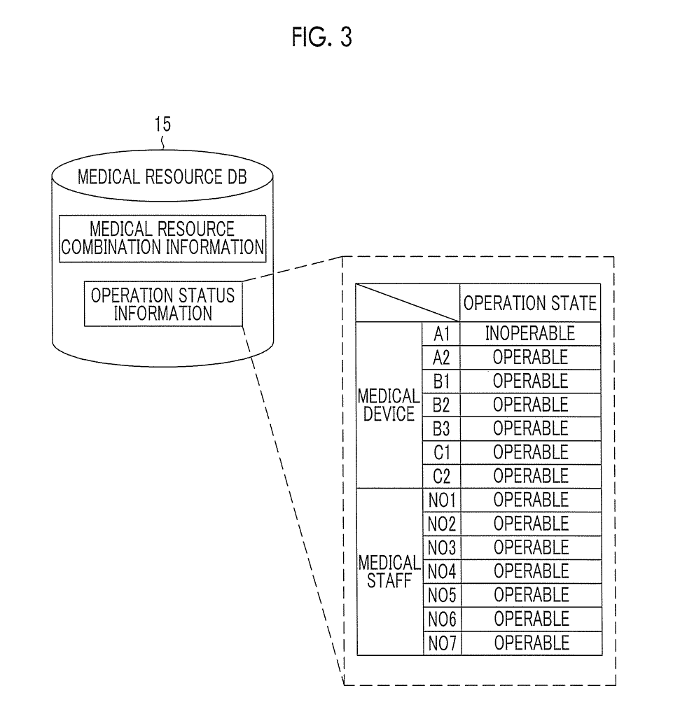

As illustrated in FIG. 3, the operation status information indicates whether each medical resource is operable or not. As described above, in the first embodiment, there are a total of 14 medical resources, that is, two medical devices A1 and A2 as the medical devices A, three medical devices B1 to B3 as the medical devices B, two medical devices C1 and C2 as the medical devices C, and seven medical staffs NO1 to NO7. Therefore, in the first embodiment, data indicating whether each of the 14 medical resources is operable or inoperable is stored as the operation status information in the medical resource DB 15. In FIG. 3, an index “operable” indicates that the medical resource is operable and an index “inoperable” indicates that the corresponding medical resource is inoperable. In FIG. 3, the operation status information is registered in the form of a list of all of the medical resources. However, similarly to the medical resource combination information, the operation status information may be registered so as to be distinguished for each medical facility.

The medical resource introduction server 11 and the client terminal 12 are formed by installing a control program, such as an operating system, or an application program, such as a client program or a server program, in a computer, such as a personal computer, a server computer, or a workstation.

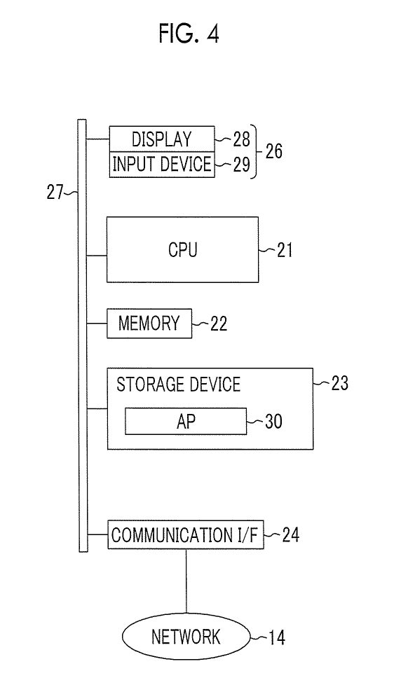

As illustrated in FIG. 4, components forming the medical resource introduction server 11 and the client terminal 12 have the same basic structure. Each of the medical resource introduction server 11 and the client terminal 12 includes a central processing unit (CPU) 21, a memory 22, a storage device 23, a communication interface (I/F) 24, and an input/output unit 26. These components are connected to each other through a data bus 27. The input/output unit 26 includes a display 28 and an input device 29 such as a keyboard or a mouse.

The storage device 23 is, for example, a hard disk drive (HDD) and stores a control program or an application program (hereinafter, referred to as an AP) 30. In addition, the storage device 23 stores installation destination list data (not illustrated) indicating the medical facilities in which each client terminal 12 is installed. It is possible to identify the medical facilities in which each client terminal 12 is installed, on the basis of the terminal installation destination list data.

The medical resource introduction server 11 in which a DB is constructed includes a disk array obtained by connecting, for example, a plurality of HDDs as a DB storage device 23, in addition to the HDD for storing programs. The disk array may be provided in a server body, or it may be provided separately from the server body and connected to the server body through a network such as a local area network (LAN).

The memory 22 is a work memory which is used by the CPU 21 to perform processes and is a random access memory (RAM). The CPU 21 loads the control program stored in the storage device 23 to the memory 22 and performs a process corresponding to the program to control the overall operation of each unit of the computer. The communication I/F 24 is a network interface which controls the transmission of data to the network 14.

A client program is installed as the AP 30 in the client terminal 12. The client program causes the client terminal 12 to have a function which accesses the medical resource introduction server 11 and transmits various requests, such as a request to update the information stored in the medical resource DB 15, a function which receives various kinds of information, such as the medical resource introduction notice transmitted from the medical resource introduction server 11 to the client terminal 12, and a function which displays, for example, an operation screen used to transmit the received introduction notice or update request.

The client program may be programmed only for the medical resource introduction system 10 or it may be a known web browser. When the client program is a web browser, for example, the client terminal 12 accesses the web site which is opened on the Internet by the operator of the medical resource introduction system 10 and the update request is transmitted through the accessed web site.

A server program is installed as the AP 30 in the medical resource introduction server 11. The server program causes the medical resource introduction server 11 to have a function which accesses the medical resource DB 15, a function which updates the information stored in the medical resource DB 15 on the basis of the update request transmitted from the client terminal 12, a function which detects the inoperable medical resources of each medical facility, a function which determines the surplus resources of each medical facility on the basis of the detected inoperable medical resources, and a function which transmits an introduction notice for introducing the determined surplus resources to the client terminal 12. The server program is registered in, for example, the start-up menu of the medical resource introduction server 11 and starts up with the operation of the medical resource introduction server 11.

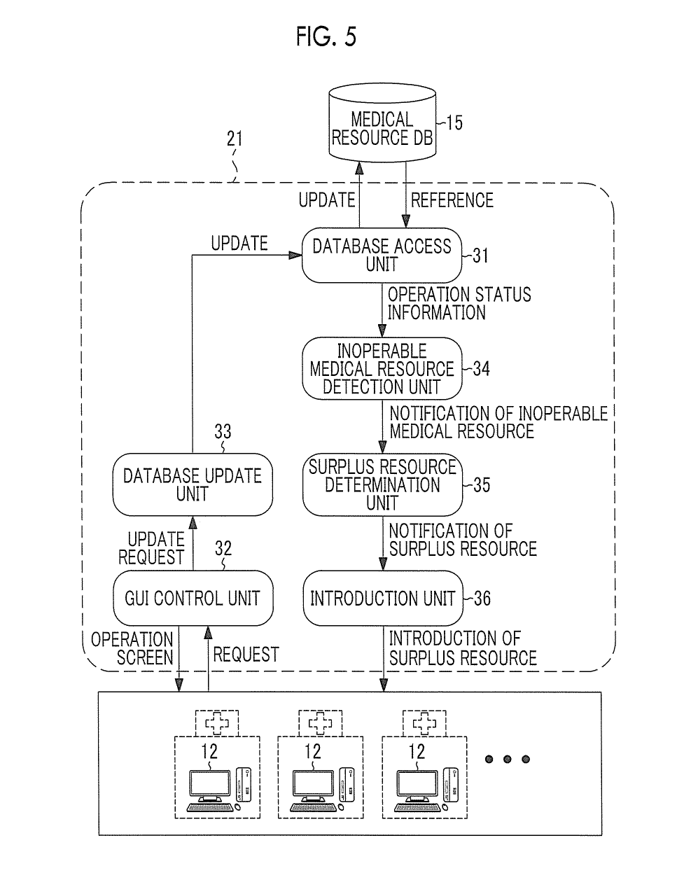

As illustrated in FIG. 5, when the server program starts up, the CPU 21 of the medical resource introduction server 11 functions as a database access unit 31, a graphical user interface (GUI) control unit 32, a database update unit 33, an inoperable medical resource detection unit 34, a surplus resource determination unit 35, and an introduction unit 36 in cooperation with, for example, the memory 22. The database access unit 31 relays various kinds of information between each unit of the medical resource introduction server 11 and the medical resource DB 15.

The GUI control unit 32 is provided in order to provide a GUI operation function to the client terminal 12, the medical resource introduction server 11, and various terminals which access the medical resource introduction server through the network 14. The GUI control unit 32 displays an operation screen for various operations on a display of the terminal to which the operation function is provided. The operation screen includes a menu screen for selecting the function to be used and an input screen for inputting the medical resource combination information or the operation status information.

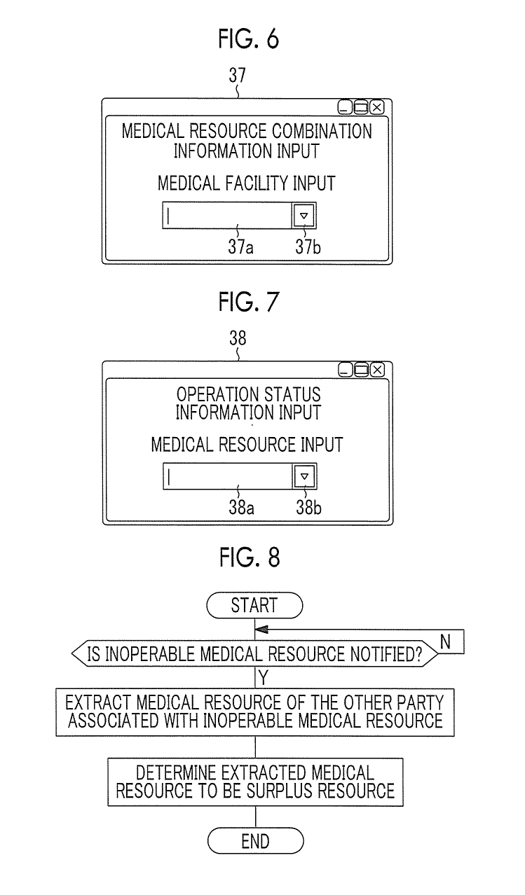

As illustrated in FIG. 6, the user operates the input device 29 to directly input a medical facility to an input field 37a or to click a drop-down button 37b on an input screen 37 for inputting the medical resource combination information, thereby selecting a medical facility from a displayed drop-down list. When the medical facility is selected, the medical resource combination information is displayed for the medical facility in which the medical resource combination information has been registered and it is possible to input the information to be changed according to the displayed medical resource combination information. In addition, for the medical facility in which the medical resource combination information has not been registered, a template for inputting new medical resource combination information is displayed and it is possible to input new medical resource combination information according to the displayed template.

As illustrated in FIG. 7, the user operates the input device 29 to directly input an inoperable medical resource to an input field 38a or to click a drop-down button 38b on an input screen 38 for inputting the operation status information, thereby selecting an inoperable medical resource from a displayed drop-down list. When the medical resource is selected, selection fields (not illustrated) for selecting whether to set the operation state of the selected medical resource to an “available (operable) state” or an “unavailable (inoperable) state” are displayed. The user clicks one of the selection fields to input the operation status information.

As described above, when an input operation is performed according to the input screen to input information about the input of new medical resource combination information or new operation status information or information about a change in the medical resource combination information or the operation status information, the input information is input as the update request to the database update unit 33. The database update unit 33 receives the update request and updates the medical resource combination information or the operation status information, that is, the medical resource DB 15 in response to the update request. In order to prevent, for example, the correction of the medical resource DB 15, the user (terminal) who can update the medical resource DB 15 is limited by, for example, a known security system.

Returning to FIG. 5, the inoperable medical resource detection unit 34 detects inoperable medical resources with reference to the operation status information stored in the medical resource DB 15 and notifies the surplus resource determination unit 35 of the detection result. For example, in the example illustrated in FIG. 3, the medical device A1 is detected as the inoperable medical resource and the detection result is transmitted to the surplus resource determination unit 35. The inoperable medical resource may be regularly or periodically detected. In addition, the inoperable medical resource may be detected at any time on the basis of the request from the user of the medical resource introduction server 11 or the client terminal 12. In addition, it may be monitored whether the operation status information is updated. When the operation status information is updated, the inoperable medical resource may be detected. Furthermore, only when a new inoperable resource is detected, the detection result may be transmitted to the surplus resource determination unit 35.

As illustrated in FIG. 8, the surplus resource determination unit 35 is operated when notified of the inoperable medical resource by the inoperable medical resource detection unit 34. The surplus resource determination unit 35 extracts the medical resource of the other party associated with the inoperable medical resource with reference to the medical resource combination information. In the first embodiment, when the inoperable medical resource is a medical device, the medical resource of the other party associated with the inoperable medical resource is a medical staff who uses the medical device. When the inoperable medical resource is a medical staff, the medical resource of the other party associated with the inoperable medical resource is the medical device used by the medical staff. For example, when the medical device A1 is detected as the inoperable medical resource (see FIG. 3), the medical staff NO1 is extracted as the medical resource of the other party associated with the medical device (see FIG. 2).

The surplus resource determination unit 35 determines whether the extracted medical resource of the other party is a medical resource which stands ready to operate due to the generation of an inoperable medical resource, that is, the surplus resource. In the first embodiment, when two medical resources form a set (see FIG. 2) and one of the two medical resources is inoperable, the other medical resource is in a standby state, that is, the other medical resource is the surplus resource. Therefore, in the first embodiment, the surplus resource determination unit 35 determines the extracted medical resource of the other party to be the surplus resource.

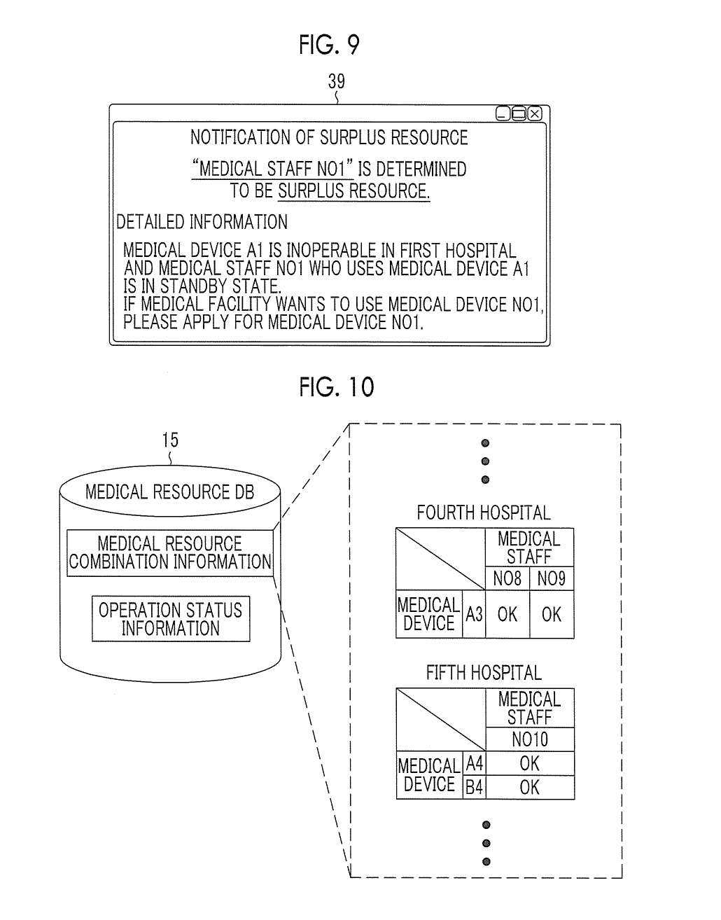

Returning to FIG. 5, the surplus resource determination unit 35 notifies the introduction unit 36 of the surplus resource and the determined medical resource. When the introduction unit 36 is notified of the surplus resource and the determined medical resource by the surplus resource determination unit 35, it generates an introduction notice indicating the type of notified medical resource or that a recipient who can effectively use the notified medical resource is being recruited and transmits the introduction notice to the client terminal 12. For example, display data for displaying an introduction screen 39 illustrated in FIG. 9 on the display 28 of the client terminal 12 is transmitted as the introduction notice. The client terminal 12 which is installed in the medical facility, which is the generation source of the surplus resources, is excluded from the destination of the introduction notice.

Next, the operation of the first embodiment will be described. In the medical resource introduction system 10, when an inoperable medical resource is detected in any of the medical facilities, it is determined whether the medical resource of the other party associated with the inoperable medical resource is the surplus resource. When it is determined that the medical resource is the surplus resource, the medical resource is introduced to other medical facilities. Specifically, when a medical device is inoperable, it is determined whether the medical staff who uses the medical device is the surplus resource. When it is determined that the medical staff is the surplus resource, the medical staff is introduced. When a medical staff is inoperable, it is determined whether the medical device used by the medical staff is the surplus resource. When it is determined that the medical device is the surplus resource, the medical device is introduced.

As described above, according to the claimed invention, when a medical device is inoperable, a medical staff is introduced. When a medical staff is inoperable, a medical device is introduced. Therefore, when it is determined whether medical resources are inoperable, that is, when the operation status information is obtained, it is possible to effectively use the surplus resources. In addition, the operation status information can be input not only from an inoperable medical facility (client terminal) (can update the medical resource DB), but also from a terminal other than the client terminal. That is, the third party can investigate and input the operation status information. Therefore, even in a situation in which the user who is a medical resource supplier or a medical resource consumer does not demand medical resources, the medical resources function effectively and it is possible to use the medical resources which will be latent surplus resources.

### Second Embodiment

Next, a second embodiment of the claimed invention will be described. In the following description, the same structures as those in the first embodiment are denoted by the same reference numerals and the description thereof will not be repeated.

As illustrated in FIG. 10, the second embodiment differs from the first embodiment in the content of information which is registered as the medical resource combination information.

Specifically, in the second embodiment, information indicating that there is one medical device A3 in a fourth hospital and the medical device A3 is shared by two medical staffs NO8 and NO9 is registered as the medical resource combination information. In addition, in the second embodiment, information indicating that there are two medical devices A4 and B4 in a fifth hospital and the two medical devices A4 and B4 are used by one medical staff NO10 is registered as the medical resource combination information. The medical devices A3 and A4 are medical devices A which are the same type as the medical devices A1 and A2 and the medical device B4 is a medical device B which is the same type as the medical devices B1 to B3.

As such, in the second embodiment, a combination (second combination) of a plurality of medical resources (a second medical resource: the medical staffs NO8 and NO9 in the fourth hospital; and the medical devices A4 and A5 in the fifth hospital) which operate in cooperation with one medical resource (a first medical resource: the medical device A3 in the fourth hospital; and the medical staff NO10 in the fifth hospital) is registered as the medical resource combination information.

Therefore, in the second embodiment, the medical resources of the other party associated (combined) with inoperable medical resources are not simply regarded as the surplus resources, unlike the first embodiment. That is, the medical resource of the other party associated with the medical staffs NO8 and NO9 is the medical device A3. Even when one of the medical staffs NO8 and NO9 is inoperable, the medical device A3 is used by the remaining medical staff and is not changed to a standby state (is not regarded as the surplus resource). Similarly, the medical resource of the other party associated with the medical devices A4 and B4 is the medical staff NO10. Even when one of the medical devices A4 and B4 is inoperable, the medical staff NO10 can use the remaining medical device. Therefore, the medical resource is not regarded as the surplus resource.

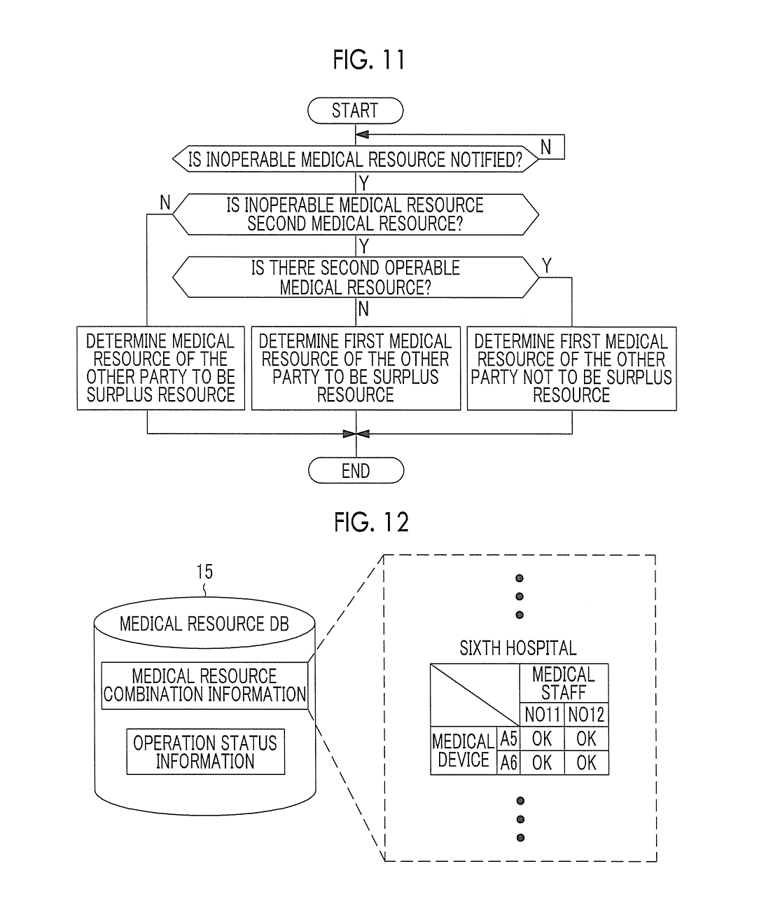

In the second embodiment, as illustrated in FIG. 11, when one of the second medical resources in the second combination is detected as the inoperable medical resource, a surplus resource determination unit 35 investigates whether there is a second operable medical resource. When there is no second operable medical resource, the surplus resource determination unit 35 determines the first medical resource associated with the second medical resource to be the surplus resource.

Specifically, the surplus resource determination unit 35 does not determine the medical device A3 (first medical resource) to be the surplus resource when only one of the medical staffs NO8 and NO9 (second medical resources) is inoperable and determines the medical device A3 to be the surplus resource when both the medical staffs NO8 and NO9 are inoperable. When the medical device A3 is inoperable, the surplus resource determination unit 35 determines both the medical staffs NO8 and NO9 to be the surplus resources.

Similarly, the surplus resource determination unit 35 does not determine the medical staff NO10 to be the surplus resource when only one of the medical devices A4 and B4 (second medical resources) is inoperable and determines the medical staff NO10 to be the surplus resource when both the medical devices A4 and B4 are inoperable. When the medical staff NO10 is inoperable, the surplus resource determination unit 35 determines both the medical devices A4 and B4 to be the surplus resources.

As such, according to the second embodiment, when only one of the medical staffs NO8 and NO9 is inoperable or when only one of the medical devices A4 and B4 is inoperable, the medical device A3 or the medical staff NO10 is not determined to be the surplus resource. Therefore, for example, it is possible to prevent the problem that, even though the medical staff NO8 is inoperable and the medical device A4 is used by the medical staff NO9, the medical device A4 is determined to be the surplus resource, that is, the medical resource which is not in a standby state is regarded as the surplus resource.

In the second embodiment, as in the example of the fourth hospital illustrated in FIG. 10, the surplus resources are determined on the basis of the assumption that, even though one of the medical staffs NO8 and NO9 is inoperable, the medical device A3 can be used (operated) by the remaining medical staff. However, for example, it is also considered that two medical staffs are needed to operate the medical device A3. In this case, when one of the medical staffs NO8 and NO9 is inoperable, not only the medical device A3 but also the remaining medical staff changes to the standby state. As such, in the situation in which one medical device is operated by a medical team of a plurality of medical staffs, when a portion of the medical team is inoperable and it is difficult to operate the medical device of the other party, both the remaining members of the medical team and the medical device of the other party may be determined to be the surplus resources.

Similarly, in the second embodiment, as in the example of the fifth hospital illustrated in FIG. 10, the surplus resources are determined on the basis of the assumption that, even through one of the medical devices A4 and B4 is inoperable, the medical staff NO10 can perform an operation (medical treatment) using the remaining medical device. However, for example, it is also considered that the medical devices A4 and B4 are operated only as a set. In this case, when one of the medical devices A4 and B4 is inoperable, both the medical staff NO10 and the remaining medical device are changed to the standby state. As such, when some of a plurality of medical devices which can be operated as a medical device set are inoperable, both the remaining medical devices and the medical staff of the other party may be determined to be the surplus resources.

In the second embodiment, for example, in the case of the sixth hospital illustrated in FIG. 12, the medical devices A5 and A6 are not determined to be the surplus resources on the basis of the assumption that, even though one of the medical staffs NO11 and NO12 is inoperable, the remaining medical staff can use both the medical devices A5 and A6. The medical devices A5 and A6 are medical devices A which are the same type as the medical devices A1 to A4.

Among the medical devices, there is a type of medical device in which two medical devices can be effectively operated by one medical staff. For example, there is a medical device, such as a computed tomography (CT) device or a magnetic resonance imaging (MRI) device, which has a relatively long inspection time. In this case, during inspection, the medical staff is in a standby state. While one patient is being inspected by one inspection device, the second patient can be inspected by the second inspection device. In addition, there is a medical device, such as an endoscopic device, which requires maintenance, such as cleaning or sweeping, after being used once. While the medical device is being cleaned or swept, the second patient can be inspected by the second inspection device. The method according to the second embodiment in which, even when a plurality of medical devices are used by one medical staff, the medical devices are not determined to be the surplus resources is effective for this type of medical device.

Among the medical devices, there is a type of medical device in which only one medical device can be operated by one medical staff, or a plurality of medical devices can be operated by one medical staff, but have low operation efficiency. When the method according to the second embodiment in which, even when a plurality of medical devices are associated with one medical staff, the medical devices are not determined to be the surplus resources is applied to this type of medical device, there is a concern that the medical resources will not be effectively used. Therefore, for this type of medical device in which only one medical device can be operated by one medical staff (or a plurality of medical devices can be operated by one medical staff, but have low operation efficiency), when a plurality of medical devices are associated with one medical staff, the second and subsequent medical devices may be determined to be the surplus resources, considering the above-mentioned properties of the medical devices.

Similarly, in the second embodiment, for example, in the case of the sixth hospital illustrated in FIG. 12, the medical staffs NO10 and NO11 are not determined to be the surplus resources on the basis of the assumption that, even though one of the medical devices A5 and A6 is inoperable, the remaining medical device can be shared by the medical staffs NO10 and NO11. However, among the medical devices, there is a type of medical device in which one medical device can be operated by a plurality of medical staffs (for example, a medical device, such as an ultrasonograph, which is not used for all of the patients every time (has a low frequency of use) and can be shared by a plurality of doctors (medical staffs)). The method according to the second embodiment in which, even when one medical device is used by a plurality of medical staffs, the medical staffs are not determined to be the surplus resources is effective for this type of medical device.

Among the medical devices, there is a type of medical device in which one medical device can only be operated by one medical staff (for example, a medical device, such as an electronic medical record input terminal, which is not capable of being shared by a plurality of doctors (or is ineffective)). When the method according to the second embodiment in which, even when a plurality of medical staffs are associated with one medical device, the medical devices are not determined to be the surplus resources is applied to this type of medical device, there is a concern that the medical resources will not be effectively used. Therefore, for this type of medical device in which one medical device can only be operated by one medical staff, when a plurality of medical staffs are associated with one medical device, the second and subsequent medical staffs may be determined to be the surplus resources, considering the above-mentioned properties of the medical devices.

The claimed invention is not limited to the above-described embodiments and the detailed structure can be appropriately changed. For example, in the above-described embodiments, the medical resource combination information is an example of the combination of the medical resources. The combination of the medical resources is not limited thereto and can be appropriately changed. As described above, a medical device set of a plurality of medical devices may be combined with one medical staff, a medical team of a plurality of medical staffs may be combined with one medical device, and the medical device set may be combined with the medical team.

As described above, when some of the medical devices forming the medical device set are inoperable, in some cases, the medical device set does not fulfill its function. In the medical device set, when some of the medical devices are inoperable, the remaining medical devices are changed to the standby state, that is, become the surplus resources. Therefore, a combination of the medical devices may be stored. When some of the medical devices are inoperable, the remaining medical devices may be determined to be the surplus resources and may be introduced.

Similarly, when some of the members in the medical team are inoperable, in some cases, the medical team does not fulfill its function. Therefore, a combination of the medical staffs may be stored. When some of the medical staffs are inoperable, the remaining medical staffs may be determined to be the surplus resources and may be introduced.

In the above-described embodiments, the medical resource which is determined to be the surplus resource is introduced to other medical facilities, regardless of the intention of the medical facility (introduction source) which holds the medical resource. However, the claimed invention is not limited thereto. The medical resource introduction server may ask the medical facility which holds the medical resources whether to introduce the medical resources, receive approval from the medical facility, and transmit the introduction notice.

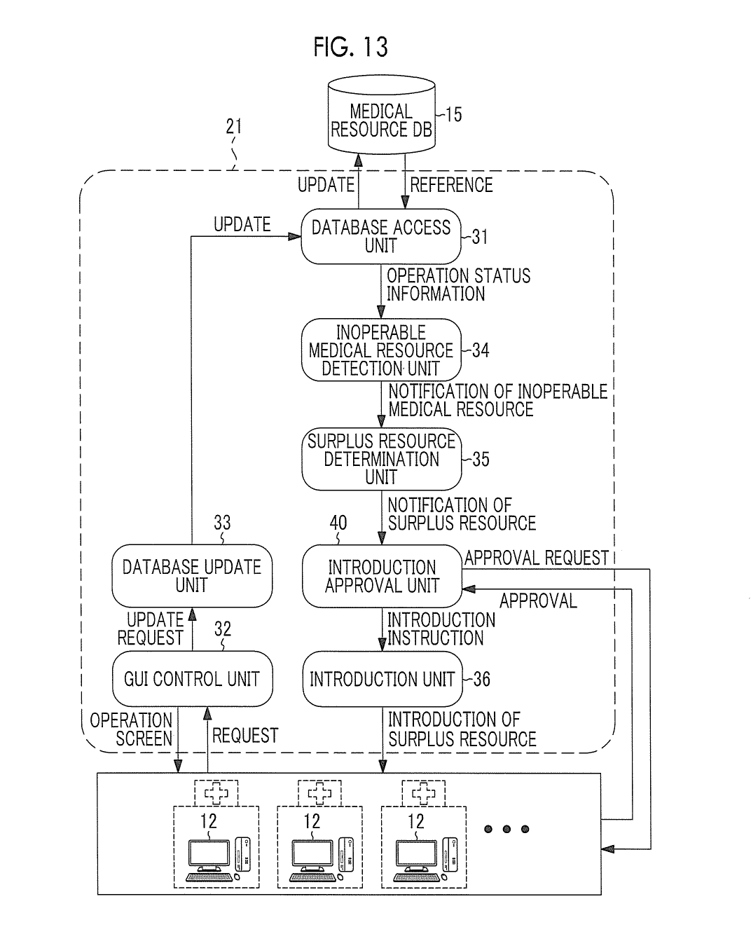

In this case, as illustrated in FIG. 13, server software which causes the CPU 21 of the medical resource introduction server 11 to function as an introduction approval unit 40 in addition to each unit according to the above-described embodiments is installed as the AP 30. When the surplus resource determination unit 35 determines any one of the medical resources to be the surplus resource, the introduction approval unit 40 transmits an approval request to obtain the approval of the introduction of the medical resource, which has been determined to be the surplus resource, to other medical facilities to the client terminal 12 installed in the medical facility which holds the medical resource. When receiving approval from the client 12 to which the approval request has been transmitted, the introduction approval unit 40 inputs an introduction instruction to the introduction unit 36. Then, when receiving the introduction, instruction, the introduction unit 36 transmits an introduction notice to the client terminals 12 which are installed in the medical facilities other than the medical facility which holds the surplus resource.

In the above-described embodiments, the introduction unit 36 introduces the surplus resource to the client terminals 12 which are installed in the medical facilities other than the medical facility which holds the surplus resource. However, the claimed invention is not limited thereto. The medical resource introduction server may be configured such that it searches for an introduction destination which can effectively use the surplus resource and introduces the surplus resource to the searched introduction destination.

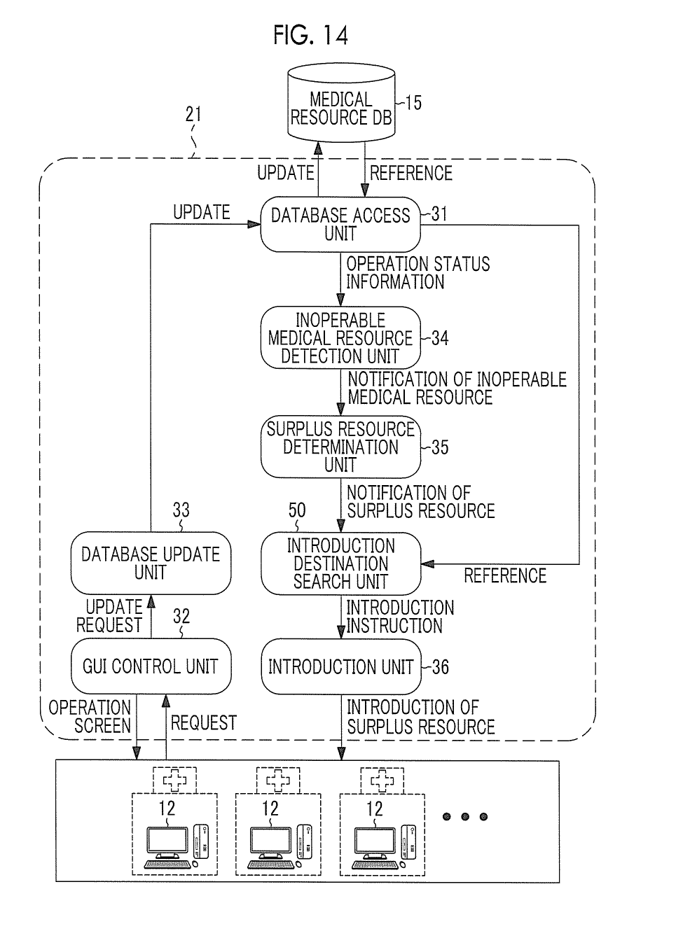

In this case, as illustrated in FIG. 14, server software which causes the CPU 21 of the medical resource introduction server 11 to function as an introduction destination search unit 50 in addition to each unit according to the above-described embodiments is installed as the AP 30. When the surplus resource determination unit 35 determines any one of the medical resources to be the surplus resource, the introduction destination search unit 50 searches for a medical facility in which the medical resource is added and does not become the surplus resource, that is, a medical facility which holds the medical resource that can be operated in cooperation with the surplus resource, on the basis of the information stored in the medical resource DB 15.

Specifically, when the medical device A1 is inoperable as illustrated in FIG. 3 and the medical staff NO1 is determined to be the surplus resource in the first hospital as illustrated in FIG. 2, the medical facility holding the medical device A that can be operated in cooperation with the medical staff NO1 is the second hospital illustrated in FIG. 2. Therefore, in this case, the second hospital is searched for as the introduction destination of the medical staff NO1.

The introduction destination search unit 50 inputs, to the introduction unit 36, an introduction instruction to introduce the surplus resource to the medical facility which has been searched for as the introduction destination. Then, the introduction unit 36 transmits an introduction notice to the client terminal 12 installed in the medical facility, which is the introduction destination, in response to the introduction instruction. According to this structure, it is possible to reliably make effective use of the surplus resource.

In the above-described embodiments, when the medical device is inoperable, the user operates, for example, the client terminal to update the operation status information. However, the claimed invention is not limited thereto. The operation status information may be automatically updated on the basis of information which is periodically transmitted from the medical resources.

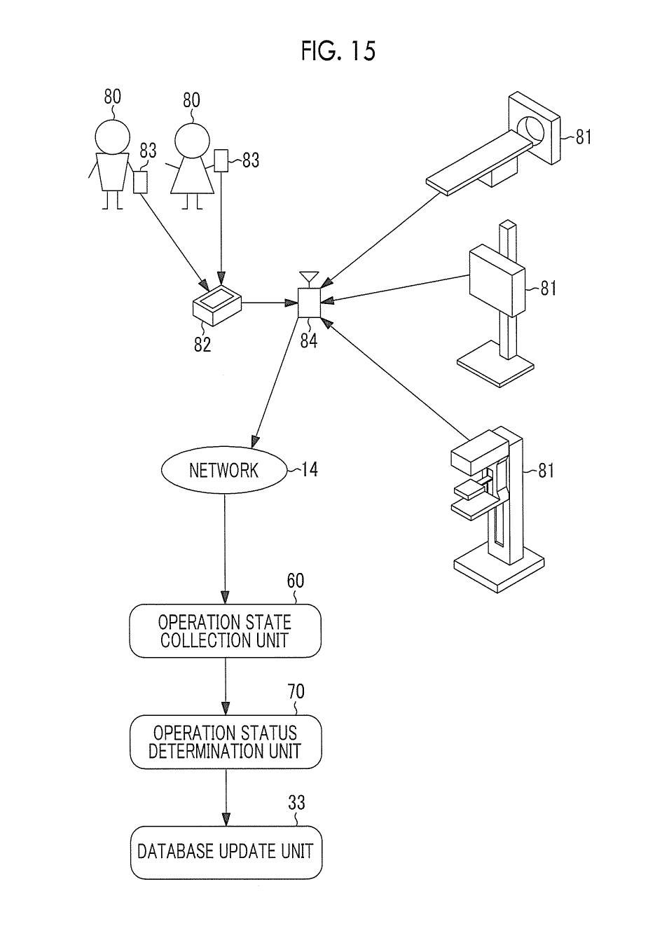

In this case, as illustrated in FIG. 15, server software which causes the CPU 21 of the medical resource introduction server 11 to function as an operation state collection unit 60 and an operation status determination unit 70 in addition to each unit according to the above-described embodiments is installed as the AP 30. The operation state collection unit 60 and the operation status determination unit are an example of an operation status information update unit according to the claimed invention. The operation state collection unit 60 is provided in order to receive the information which is periodically transmitted from the medical resources. In the example illustrated in FIG. 15, the operation state collection unit 60 receives attendance information indicating the attendance state of a medical staff 80 and power-on information indicating that a medical device 81 has been turned on.

When the medical staff 80 passes an integrated circuit (IC) card 83 through a time recorder 82 in order to enter the medical facility, the attendance information is transmitted from the time recorder 82 to the operation state collection unit 60 through an access point 84 and the network 14. When the medical device 81 is turned on, the power-on information is transmitted from the medical device 81 to the operation state collection unit 60 through the access point 84 and the network 14.

The operation status determination unit 70 determines an inoperable medical resource on the basis of the information collected by the operation state collection unit 60 as described above. Specifically, when it is detected that the medical staff 80 has not come to work for a predetermined period or more, the operation status determination unit 70 determines that the medical staff 80 is inoperable on the basis of the attendance information. When it is detected that the medical device 81 has not been turned on for a predetermined period or more, the operation status determination unit 70 determines that the medical device 81 is inoperable on the basis of the power-on information. When the inoperable medical resource is determined, the operation status determination unit 70 transmits an update request to change the operation status information of the medical resource to the database update unit 33. The database update unit 33 updates the operation status information stored in the medical resource DB 15 on the basis of the transmitted update request. As in this example, when the operation status information is automatically updated, the user does not need to perform any operation until the surplus resource is introduced. Therefore, according to this example, it is possible to reliably make effective use of latent surplus resources.

The claimed invention is not limited to the above-described embodiments or the above-described modifications and various changes and modifications of the claimed invention can be made without departing from the scope and spirit of the claimed invention. For example, the above-described embodiments and the above-described modifications may be appropriately combined with each other. The claimed invention can be applied to a storage medium storing the program, in addition to the program.

What is claimed is:

1. A medical resource introduction device that introduces medical resources including at least one of medical devices and medical staffs held by a plurality of medical facilities to the plurality of medical facilities in order to circulate the medical resources between the plurality of medical facilities, comprising:
a database access unit that accesses a medical resource database storing medical resource combination information and operation status information, the medical resource combination information registering at least one combination of the medical resources that are operated in cooperation with each other in each medical facility, the operation status information indicating whether each of the medical resources held by each medical facility is operable or inoperable;
an inoperable medical resource detection unit that detects an inoperable medical resource among the medical resources included in the combination, based on the operation status information;
a surplus resource determination unit that, in a case where the inoperable medical resource detection unit detects the inoperable medical resource, investigates whether there is a medical resource of which status is changed to a standby state in which the medical resource stands by to be operated due to an occurrence of the inoperable medical resource, based on the medical resource combination information, and determines that the medical resource is a surplus resource in a case where there is the medical resource of which status is changed to the standby state; and
an introduction unit that introduces the surplus resource to any of the plurality of medical facilities.

2. The medical resource introduction device according to claim 1,
wherein the medical resource combination information includes a first combination, which is a pair of the medical resources, and
wherein, in a case where one of the medical resources consisting the first combination is detected as the inoperable medical resource, the surplus resource determination unit determines the other medical resource of the first combination, which makes the pair with the inoperable medical resource, as the surplus resource.

3. The medical resource introduction device according to claim 1,
wherein the medical resource combination information includes a second combination of at least one first medical resource and a plurality of second medical resources which are operated in cooperation with the first medical resource among the medical resources, and
wherein, in a case where the second medical resources are detected as the inoperable medical resource and there is no second medical resource that is operable in the second combination, the surplus resource determination unit determines the first medical resource as the surplus resource.

4. The medical resource introduction device according to claim 2,
wherein the medical resource combination information includes a second combination of at least one first medical resource and a plurality of second medical resources which are operated in cooperation with the first medical resource among the medical resources, and
when, in a case where the second medical resources are detected as the inoperable medical resource and there is no second medical resource that is operable in the second combination, the surplus resource determination unit determines the first medical resource as the surplus resource.

5. The medical resource introduction device according to claim 1,
wherein the combination of the medical resources includes a combination in which one of the medical resources is the medical staff and the other which constitutes the combination with the medical staff is the medical device.

6. The medical resource introduction device according to claim 2,
wherein the combination of the medical resources includes a combination in which one of the medical resources is the medical staff and the other which constitutes the combination with the medical staff is the medical device.

7. The medical resource introduction device according to claim 3,
wherein the combination of the medical resources includes a combination in which one of the medical resources is the medical staff and the other which constitutes the combination with the medical staff is the medical device.

8. The medical resource introduction device according to claim 4,
wherein the combination of the medical resources includes a combination in which one of the medical resources is the medical staff and the other which constitutes the combination with the medical staff is the medical device.

9. The medical resource introduction device according to claim 1,
wherein, in a case where there is the surplus resource in one medical facility, the introduction unit searches for a medical facility having a medical resource that is capable of being operated in cooperation with the surplus resource from the medical resource database and introduces the surplus resource to the searched medical facility.

10. The medical resource introduction device according to claim 2,
wherein, in a case where there is the surplus resource in one medical facility, the introduction unit searches for a medical facility having a medical resource that is capable of being operated in cooperation with the surplus resource from the medical resource database and introduces the surplus resource to the searched medical facility.

11. The medical resource introduction device according to claim 3,
wherein, in a case where there is the surplus resource in one medical facility, the introduction unit searches for a medical facility having a medical resource that is capable of being operated in cooperation with the surplus resource from the medical resource database and introduces the surplus resource to the searched medical facility.

12. The medical resource introduction device according to claim 4,
wherein, in a case where there is the surplus resource in one medical facility, the introduction unit searches for a medical facility having a medical resource that is capable of being operated in cooperation with the surplus resource from the medical resource database and introduces the surplus resource to the searched medical facility.

13. The medical resource introduction device according to claim 1, further comprising:
an approval unit that, before the introduction unit introduces the surplus resource, inquires of the medical facility, which is an introduction source having the surplus resource, about the introduction of the surplus resource and obtains the approval of the introduction from the medical facility, which is the introduction source.

14. The medical resource introduction device according to claim 2, further comprising:
an approval unit that, before the introduction unit introduces the surplus resource, inquires of the medical facility, which is an introduction source having the surplus resource, about the introduction of the surplus resource and obtains the approval of the introduction from the medical facility, which is the introduction source.

15. The medical resource introduction device according to claim 3, further comprising:
an approval unit that, before the introduction unit introduces the surplus resource, inquires of the medical facility, which is an introduction source having the surplus resource, about the introduction of the surplus resource and obtains the approval of the introduction from the medical facility, which is the introduction source.

16. The medical resource introduction device according to claim 4, further comprising:
an approval unit that, before the introduction unit introduces the surplus resource, inquires of the medical facility, which is an introduction source having the surplus resource, about the introduction of the surplus resource and obtains the approval of the introduction from the medical facility, which is the introduction source.

17. The medical resource introduction device according to claim 1, further comprising:
an operation status information update unit that updates the operation status information based on information which is periodically transmitted from the medical resource.

18. A medical resource introduction system that introduces medical resources including at least one of medical devices and medical staffs held by a plurality of medical facilities to the plurality of medical facilities in order to circulate the medical resources between the plurality of medical facilities, comprising:
client terminals that are installed in each of the plurality of medical facilities; and
a medical resource introduction device that introduces the medical resources to the client terminals,
wherein the medical resource introduction device includes:
a database access unit that accesses a medical resource database storing medical resource combination information and operation status information, the medical resource information registering at least one combination of the medical resources that are operated in cooperation with each other, the operation status information indicating whether each of the medical resources is operable or inoperable in such a manner that the medical facilities holding each medical resource can be identified;
an inoperable medical resource detection unit that detects an inoperable medical resource among the medical resources included in the combination, based on the operation status information;
a surplus resource determination unit that, in a case where the inoperable medical resource detection unit detects the inoperable medical resource, investigates whether there is a medical resource of which status is changed to a standby state in which the medical resource stands by to be operated due to an occurrence of the inoperable medical resource, based on the medical resource combination information, and determines that the medical resource is a surplus resource in a case where there is the medical resource of which status is changed to the standby state; and
an introduction unit that introduces the surplus resource to any of the plurality of medical facilities.

19. A non-transitory computer-readable recording medium storing a medical resource introduction program that causes a computer to function as a medical resource introduction device which introduces medical resources including at least one of medical devices and medical staffs held by a plurality of medical facilities to the plurality of medical facilities in order to circulate the medical resources between the plurality of medical facilities and causes the computer to perform:
a database access step of accessing a medical resource database storing medical resource combination information and operation status information, the medical resource combination information registering at least one combination of the medical resources that are operated in cooperation with each other, the operation status information indicating whether each of the medical resources is operable or inoperable such that the medical facilities holding each medical resource can be identified;
an inoperable medical resource detection step of detecting an inoperable medical resource among the medical resources included in the combination, based on the operation status information;
a surplus resource determination step of, in a case where the inoperable medical resource is detected in the inoperable medical resource detection step, investigating whether there is a medical resource of which status is changed to a standby state in which the medical resource stands by to be operated due to the occurrence of the inoperable medical resource, based on the medical resource combination information, and determining that the medical resource is a surplus resource in a case where there is the medical resource of which status is changed to the standby state; and
an introduction step of introducing the surplus resource to any of the plurality of medical facilities.

20. A method for operating a medical resource introduction device that introduces medical resources including at least one of medical devices and medical staffs held by a plurality of medical facilities to the plurality of medical facilities in order to circulate the medical resources between the plurality of medical facilities, the method comprising:
a database access step of accessing a medical resource database storing medical resource combination information and operation status information, the medical resource combination information registering one combination of the medical resources that are operated in cooperation with each other, the operation status information indicating whether each of the medical resources is operable or inoperable in such a manner that the medical facilities holding each medical resource can be identified;
an inoperable medical resource detection step of detecting an inoperable medical resource among the medical resources included in the combination, based on the operation status information;
a surplus resource determination step of, in a case where the inoperable medical resource is detected in the inoperable medical resource detection step, investigating whether there is a medical resource of which status is changed to a standby state in which the medical resource stands by to be operated due to the occurrence of the inoperable medical resource, based on the medical resource combination information, and determining that the medical resource is a surplus resource in a case where there is the medical resource of which status is changed to the standby state; and
an introduction step of introducing the surplus resource to any of the plurality of medical facilities.
